(19) United States
(12) Patent Application Publication
(10) Pub. No.: US 2023/0046957 A1
(43) Pub. Date: Feb. 16, 2023

(54) NUT CRACKER

(71) Applicant: Christoper Laurence Dunshea, Mbombela (ZA)

(72) Inventor: Anthony Walter Berlein, Mbombela (ZA)

(21) Appl. No.: 17/783,521

(22) PCT Filed: Dec. 8, 2020
(86) PCT No.: PCT/IB2020/061624

§ 371 Date: Jun. 8, 2022

(30) Foreign Application Priority Data
Dec. 9, 2019 (ZA) 2019/07766

(51) Int. Cl. A23N 5/00

(52) U.S. Cl. CPC A23N 5/00

(57) ABSTRACT

A nut cracker (1) comprising a base (9) adjustably secured to a supporting surface (3), a set of cracker plates (6A, 6B) comprising a movable plate (6B) and fixed plate (6A) defining a cracking space (21) with a predeterminable size with an inlet and an outlet, the fixed plate (6A) being adjustably secured to the supporting surface (3) and the movable plate (6B) being adjustably secured to at least one slide (8) secured to the base (9), with angles of the fixed and movable plates (6A, 6B) relative to their support planes being adjustable between 45° and 90°, the base (9) being slidingly adjustable relative to the supporting surface (3) to adjust and set the mean size of the cracking space (21), the movable plate (6B) being driven by reciprocating drive means (14) which reciprocally moves the movable plate (6B) with respect to the fixed plate (6A) on the slide (8).

### FIELD OF THE INVENTION

This invention relates to a cracker for stone fruit nuts.

### BACKGROUND TO THE INVENTION

Pecan trees (Carya iffinoinensis) produce fruits that include a single stone or pit, surrounded by a husk. The husk is produced from the exocarp tissue of the flower, while the part known as the nut develops from the endocarp and contains the seed. The husk itself is aeneous in colour, shaped oval to oblong, and typically about 2.6 to 6 cm long and 1.5 to 3 cm broad. The outer husk is typically about 3 to 4 mm thick, starts out green in colour which turns to brown at maturity, at which time it splits off in four sections to release the thin-shelled nut. The pecan nut meat is dicotyledonous, having two halves.

Cracking and shelling stone fruit nuts, including pecan nuts, and removing the edible nut meat with minimal breakage is the ultimate aim of most nut processing operations. By way of example, in the case of pecan nuts, modern mechanical shelling operations typically recover between 50% to 75% unbroken nut meats.

Various techniques are applied to crack nuts, many of which include some form of mechanical breaking. The mechanical action of breaking a nut without damaging the nut meat is a very delicate balance between applying enough force to crack the shell but not so much force that the shell, or pieces thereof, is forced into the nut meat which could damage it. Automating this process is complicated.

Advanced processes have been developed which improves the recovery rates of stone fruit nuts from their nuts. Despite these advances such processes still have room for improvement and they generally require suitably fine-tuned and optimized nut crackers. Prior art nut crackers do not fulfil this requirement.

### OBJECTIVE OF THE INVENTION

It is an objective of the invention to provide a nut cracker which at least partly overcomes the abovementioned problems.

### SUMMARY OF THE INVENTION

In accordance with the invention there is provided a nut cracker comprising a base adjustably secured to a supporting surface, a set of cracker plates comprising a movable plate and fixed plate defining between them a cracking space with a predeterminable size, the cracking space having an inlet to it at operatively top ends of the plates and an outlet from it at operatively bottom ends of the plates, the fixed plate being adjustably secured to the supporting surface and the movable plate being adjustably secured to at least one slide secured to the base, with:
the angle of the fixed plate relative to a plane within which the supporting surface is located being adjustable between 45° and 90°,
the angle of the movable plate relative to a plane within which the base is located being adjustable between 45° and 90°,

the base being slidingly adjustable relative to the supporting surface to adjust and set the distance between the movable plate and the fixed plate to set a mean size of the cracking space,

the movable plate being movable with respect to the fixed plate with a reciprocating motion along a path parallel to a plane within which the base is located and being constrained for the reciprocating motion by the slide which is slidable between extremities that provide a range of movement greater than a range of the reciprocating movement of the movable plate, and

the movable plate being configured to be reciprocally moved by reciprocating drive means that is secured to the base and which reciprocally moves the movable plate on the slide relatively to the base.

There is further provide for the angle of the fixed plate relative to the plane within which the supporting surface is located to be adjustable preferably between 60° and 70°, and for the angle of the movable plate relative to the plane within which the base is located to be adjustable preferably between 60° and 70°.

There is further provided for the base and the supporting surface to be located in parallel planes.

There is further provided for the fixed plate to be secured to the supporting surface by means of a set of braces extending from the fixed plate, preferably from a rear surface of the fixed plate,

with the set of braces being securable to a complimentary set of upright supports extending from the supporting surface, preferably extending upwards from the supporting surface, and

for each brace from the set of braces to be slidably securable to an upright support by means of a pin pivotally extending through complimentary apertures through each brace and upright support, with at least one of either brace or support including a slot enabling sliding adjustment of the pin, and operatively enabling adjustment of the angle of the fixed plate relative to the plane within which the supporting surface is located.

There is still further provided for the movable plate to be secured to the slide by means of a set of braces extending from the movable plate, preferably from a rear surface of the movable plate,

with the set of braces being securable to a complimentary set of upright supports extending from the slide, preferably extending upwards from the slide, and

for each brace from the set of braces to be slidably securable to an upright support by means of a pin pivotally extending through complimentary apertures through each brace and upright support, with at least one of either brace or support including a slot enabling sliding adjustment of the pin securing the brace and upright support, and operatively enabling adjustment of the angle of the movable plate relative to the plane within which the base is located.

There is further provided for the base to be provided with a set of spaced apart slides, and for each slide to have an upright support secured to and extending upwards from it, and with each upright support being slidingly secured to a brace of the movable plate.

There is still further provided for the two slides to be secured together by means of a mounting plate located operatively above the slides, and for the two upright supports to be secured to and extend upwards from the mounting plate.

There is further provided for the mounting plate to carry a set of bearings rotatably supporting a driven shaft, which is connected by means of a connection rod to a reciprocating drive shaft, which forms part of the reciprocating drive means.

There is further provided for the reciprocating drive means to comprise a motor with a drive shaft secured to an eccentric driven shaft, preferably by means of a drive belt through a set of pulleys configured to provide a suitable gearing between the motor and the eccentric driven shaft, with the eccentric driven shaft comprising the reciprocating drive shaft, and being connected to the driven shaft by means of the connecting rod that is secured to an eccentric lobe located centrally on the reciprocating drive shaft, and with the reciprocating drive shaft including a set of weights on opposing sides of the eccentric lobe with the weights being co-axial to a central axis of the reciprocating drive shaft.

There is also provided for the range of the reciprocating movement of the movable plate to be determined by installing an eccentric driven shaft with a throw of the same distance as a desired range of the reciprocating movement, and preferably for the eccentric lobe to have a throw of 8 mm, 10 mm, or 12 mm.

There is further provided for the plates of the nut cracker to be located between two end brackets to provide closed sides for the cracking space.

There is further provided for the base to be secured to a worm gear assembly on the supporting surface configured to allow controlled movement of the base relative to the supporting surface, operatively to adjust and set the mean size of the cracking space.

There is also provided for the supporting surface to comprise a top of a table having four height adjustable and tilt adjustable legs.

These and other features of the invention are described in more detail below.

### BRIEF DESCRIPTION OF THE DRAWINGS

A preferred embodiment of the invention is described by way of example only and with reference to the accompanying drawings in which:

FIG. 1 is a top-right rear perspective view of a nut cracker according to the invention;

FIG. 2 right side elevation of the nut cracker of FIG. 1;

FIG. 3 is a top-left rear perspective view of the nut cracker of FIG. 1, excluding the legs;

FIG. 4 right side elevation of the nut cracker of FIG. 1, excluding the legs;

FIG. 5 is a side elevation of one of the cracker plates of the cracker of FIG. 1;

FIG. 6 shows detail A from FIG. 5;

FIG. 7 is a top perspective view of the driven shaft and connecting rod of the cracker of FIG. 1;

FIG. 8 is a side elevation of the driven shaft and connecting rod shown in FIG. 7;

FIG. 9 shows section C-C from FIG. 8; and

FIG. 10 shows a side elevation of the nut cracker shown in FIG. 3, with the angle of its cracker plates adjusted for operation.

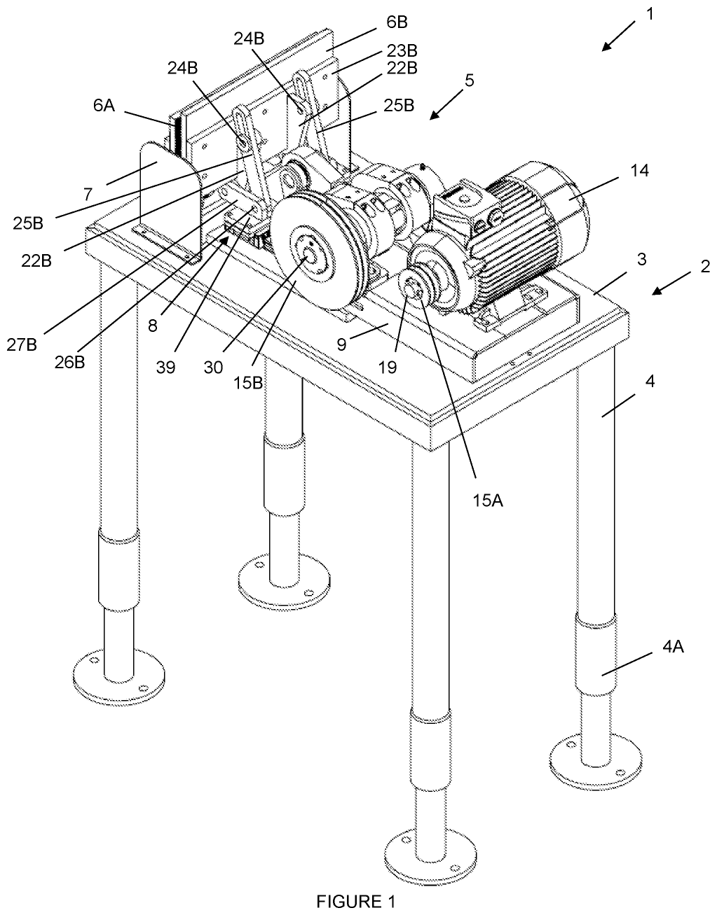

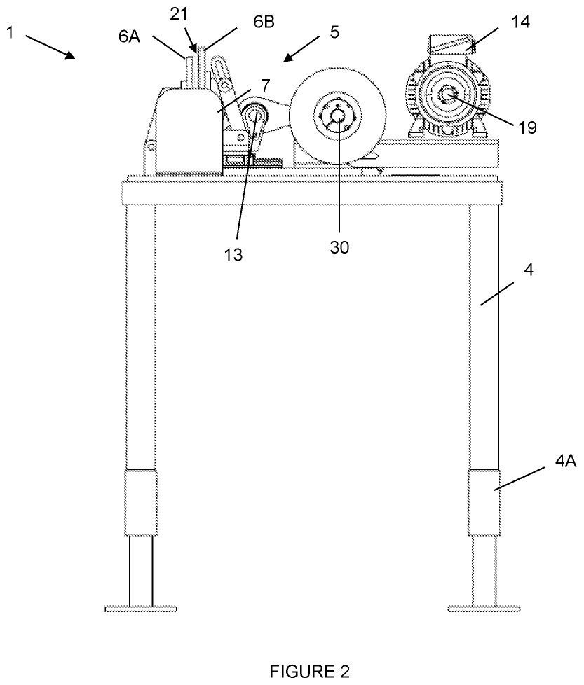

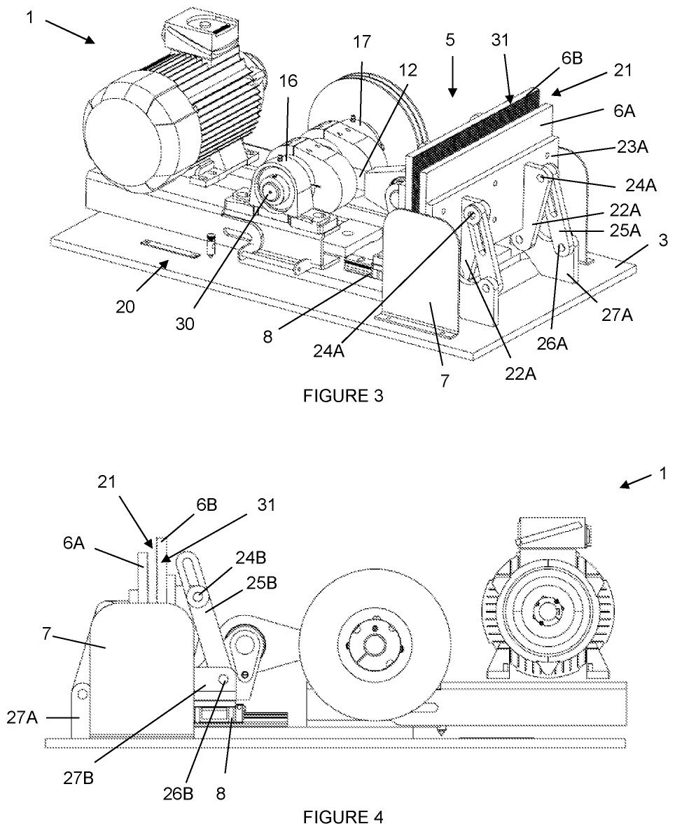

### DETAILED DESCRIPTION OF THE INVENTION

The applicant has established that it is beneficial for the cracking of stone fruit nuts to apply a force to such nuts that is substantially perpendicular to the longitudinal axis of the nuts—i.e., a side impact or side force on the nuts. This, it is believed, assists in the cracking of the nut by applying a pure compressive force to the shell, without rolling the nuts and without attempting to break the nuts between their longitudinal ends.

The nut cracker (1) according to the invention facilitates this and comprises a frame (2) with a flat top (3) supported by four individually height adjustable (4A) legs (4), to allow the top (3) to be installed horizontally level, irrespective of irregularities in a floor surface on which it is installed. The top (3) supports the cracker assembly (5).

The cracker assembly (5) includes a set of two plates (6A, 6B) that define between them a cracking space (21). In this preferred embodiment one plate is a fixed plate (6A) and it is secured in position between end brackets (7) that are secured to the top (3). The fixed plate (6A) is maintained stationary relative to the top (3) and the two end brackets (7). The angle of the fixed plate (6A) is adjustable relative to the plane within the supporting surface, i.e., the top (3), is located. This is done by means of a set of two spaced apart brackets (22A) extending from the outer surface of a base plate (23A) to which the fixed plate (6A) is mounted, with each of the brackets (22A) being slidingly securable (24A) to an arm (25A) that is pivotally secured (26A) to a brace (27A) that extends upwards from the top (3).

The angle of the fixed plate (6A) is adjustable between about 45° to 90°, measured upwards (i.e., relative to the plane within the top (3) is located) from a point of rotation at the bottom of the fixed plate. A setting of 90° corresponds with a completely vertical fixed plate (6A), and a setting of 45° corresponds with a fixed plate (6A) to is located horizontally, both relative to the top (3).

In a preferred embodiment as shown in FIG. 10, angular adjustment of the fixed plate (6A) is shown, and it is shown to be set at an angle of about 70° (33), which means the inner surface (34) of the fixed plate (6A) is visible when viewed directly from above. This means the inner surface (34) will be presented as a ‘landing’ surface on which nuts being fed into the cracker (1) can land, instead of potentially falling through the cracking space (21).

The second plate (6B) of the two plates (6) is a movable plate, and it is movable relative to the fixed plate (6A) in a reciprocating manner. To achieve the reciprocating movement the movable plate (6B) is mounted on a mounting plate (39) that is secured onto a set of slides (8), which in turn are secured onto a base (9) that is slidingly secured to the top (3). As will be explained further, the adjustment of the base (9) relative to the top (3) is done to adjust and set the mean size of the gap of the cracking space (21).

The slides (8) constrain movement of the movable plate (6B) relative the fixed plate (6A) to reciprocating movement within in a plane that is parallel to the top (3). The slides (8) thus provide a path of constrained reciprocating movement for the movable slide (6B), whilst the actual angle of the movable plate (6B) relative to the fixed plate (6A), and thus also relative to the top (3), is adjustable.

Similar to the fixed plate (6A), the angle of the movable plate (6B) relative to vertical is also adjustable, by means of a set of two spaced apart brackets (22B) extending from the outer surface (23B) of the movable plate (6B), each of which is slidingly securable (24B) to an arm (25B) that is pivotally secured (26B) to a brace (27B) that extends upwards from the mounting plate (39) on the slides (8). Each brace (27B) is secured to the mounting plate (39) which in turns is secured the to the slides (8), so there is no relative movement between a slide (27B) and its associated brace (8).

The drive means for the cracker assembly (5) comprises a motor (14) with a drive shaft (19) that is secured to an eccentric driven shaft (30) by means of a drive belt (not shown) through a set of pulleys (15A, 15B). The pulleys (15) are configured to provide a suitable gearing between the motor (14) and the eccentric driven shaft (30).

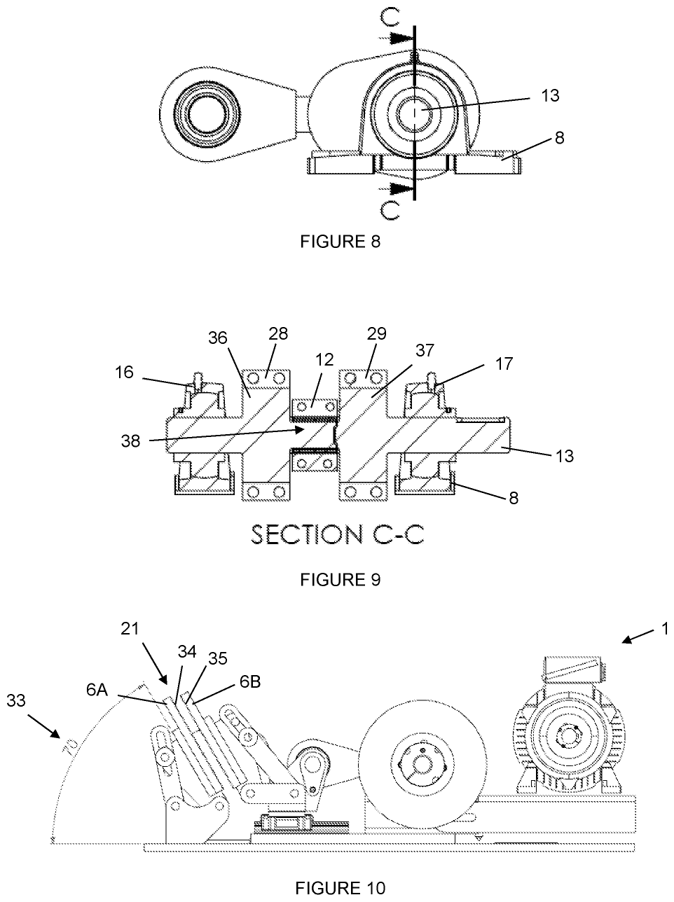

As shown in in FIGS. 7-9, the eccentric driven shaft (30) is the reciprocating drive shaft for the cracker assembly (5), and it is shaped as a camshaft, with a concentric portion that each carries a weight (28, 29) adjacent a bearing (16, 17) that is secured to the base (9) to rotatably support the eccentric driven shaft (30). The weights (28, 29) are arranged coaxially to a central axis of the eccentric drive shaft (30). Between the weights (28, 29) a connecting rod (12) is rotatably secured to an eccentric lobe (38) on the shaft (30). The distance by which this eccentric lobe (38) is offset from the axis of the shaft (30) determines the throw of the eccentric driven shaft (30), and the extent of the reciprocating rotational motion imparted on the movable plate (6B). In this embodiment the eccentric lobe (38) is offset by 10 mm, which means the range of the reciprocating motion of the movable plate (6B) is 10 mm.

To change the range of the reciprocating motion of the movable plate (6B) the eccentric driven shaft (30) is replaced by one with a different throw, for example 8 mm or 12 mm. This provides for a simple fixed adjustment of the range of the reciprocating motion of the movable plate (6B), which does not introduce additional variables into the cracker assembly (5) that could lead to instability of inaccuracy. Also, the replacement of the eccentric driven shaft (30) is easy and can be done relatively fast.

The connecting rod (12) is rotatably secured at its other end around a driven shaft (13). The driven shaft is located between two gussets that extend upwards from the mounting plate (39). The head of the connecting rod (12) pulls and pushes the mounting plate (39) on the slides (8), as dictated by the reciprocating rotational motion the connecting rod (12) receives from the eccentric drive shaft (30).

The electric motor (14) is also secured to the base (9). The base (9) is slidingly secured to the top surface (3), which allows the position of the base (9) relative to the fixed plate (6A) to be adjusted and set by means of a worm gear (not shown) with a handle (not shown). The top (3) is provided with a measurement index (20) that indicates the adjustment of the base (9) relative to the fixed plate (6A), with an absolute minimum distance of zero that equals the plates (6A, 6B) touching and the cracking space (21) being zero.

The sliding movement of the base (9) relative to the fixed plate (6A) allows the minimum distance between the two plates (6A, 6B) to be adjusted and set according to the size range of a batch of nuts that are to be processed through the cracker (1). The amplitude of reciprocation of the movable plate (6B) around the reciprocating shaft (30) determines the maximum distance between the two plates (6A, 6B).

The amplitude of reciprocation thus effectively determines the difference between the above-mentioned maximum and minimum distances between the plates (6A, 6B). This defines the gap, i.e., the cracking space (21), between the pates and is determined by the mean size of nuts that are to be cracked in the nut cracker (1). The minimum distance is adjustable to accommodate batches of various mean sizes. The maximum distance is determined by the offset at which the connecting rod (12) is secured relative to the reciprocating shaft (30), on its central offset lobe (38).

In a typical configuration for the cracking of for example pecan nuts the offset, and therefore also the amplitude of reciprocation, is 10 mm. For such pecan nuts, that may for example have a diameter across its longitudinal axis of about 13 mm, the minimum distance between the two plates (6A, 6B) may be set at 12 mm. The 10 mm amplitude of reciprocation means that the maximum distance between the plates (relative to the 12 mm minimum gap) will be about 22 mm.

The minimum distance between the plates, 12 mm in this example, is thus measured at the bottoms of the plates, and this is set that nuts can only move into the cracking space (21) on their sides. The reciprocation motion applies a force across the side of the nut, not end-to-end. Since nuts are sorted in batches and each batch has a mean distribution of sizes across its size range, the gap at the inlet to the cracking space (21) is set slightly larger than the gap at the outlet from the cracking space (21) to allow for slight variations in mean nut size.

As mentioned above and shown in FIG. 10, this is achieved by setting the angle of the movable plate to be slightly less than the angle of the fixed plate (6A), which creates a slight tapering of the gap between them. For the above-mentioned setting of about 70° of the fixed plate angle, the movable plate (6B) may be set at about 72°, viewed from the same reference point that was used for the fixed plate. The 2° difference in setting means the movable plate is 2° closer to vertical than the fixed plate (6A), and this creates a slightly larger gap between the plates at their top (in use the entrance for nuts) compared to at their bottoms (in use the exit for nuts).

This means the gap is tapered. The inlet gap is selected to be just larger than (or the same as) the maximum allowable size in the batch, and the outlet size is selected to be just smaller than (or the same as) the minimum allowable size in the batch. This means all nuts in the batch can enter the cracking space (21), and all nuts will be subjected somewhere along the tapered cracking space (21) to a pure compressive force on their sides. Each nut will roll down into the cracking space (21) until it reaches a depth where the reciprocating motion of the movable plate (6B) compresses it on its side.

Since the fixed plate (6A) is set at about 70° (33), its inner surface (34) is presented to nuts to fall onto when they enter the cracking space (21). This prevents nuts from falling right through the cracking space (21) when the moving plate (6B) is at the point furthest in the reciprocating stroke—in this example it will create at its maximum a gap that is 22 mm, which is the minimum gap set of 12 mm plus the 10 mm reciprocating stroke length.

If the fixed plate (6A) was angled straight up, i.e. at 90° relative to the plane of the top (3), it creates a clear path through which a nut could conceivably fall depending on the speed with which the motor (14) rotates for opening and closing of the cracking space. A faster rotation decreases time that such a gap is fully open. To avoid having to rely on this speed at which the cracking space (21) is opened and closed to prevent nuts falling through the cracking space (21), the fixed plate (6A) and thus also the movable plate (6B) is set at less than 90°. Towards the other end of the range, if the plates are set at less than 45°, the effect of gravity on the nuts moving through the cracking space is minimized significantly and there is a greater risk that nuts may be pushed out of the top of the cracking space (21). For this reason, an angle setting of between 45° and 90° is used, and a preferred range is between 60° and 70°. In this embodiment it is set at 70° (33).

To assist in achieving the movement of the nuts through the crackling space, nuts may be fed into the cracking space (21) on a chute (not shown) that is aligned with the fixed plate (6A). Such a setup allows nuts to be fed into the cracking space (21), with gravity ensuring that the nuts drop onto the inner surface (34) of the fixed plate (6A). Even if the nuts hit the inner surface (35) of the movable plate (6B), it still achieves the goal of limiting a nut from falling straight through the cracking space (21).

The taper may also be adjusted depending on the size range to which a batch of nuts is sorted. If the size range is larger, then the taper could be increased to provide space for larger nuts to move into the cracking space (21) without blocking it.

The cracker (1) is configured for nuts to be fed into the top of the cracking space (21), cracked across their sides and along with the broken shell pieces drops free from the outlet from the cracking space (21) at the bottom of the cracker (1).

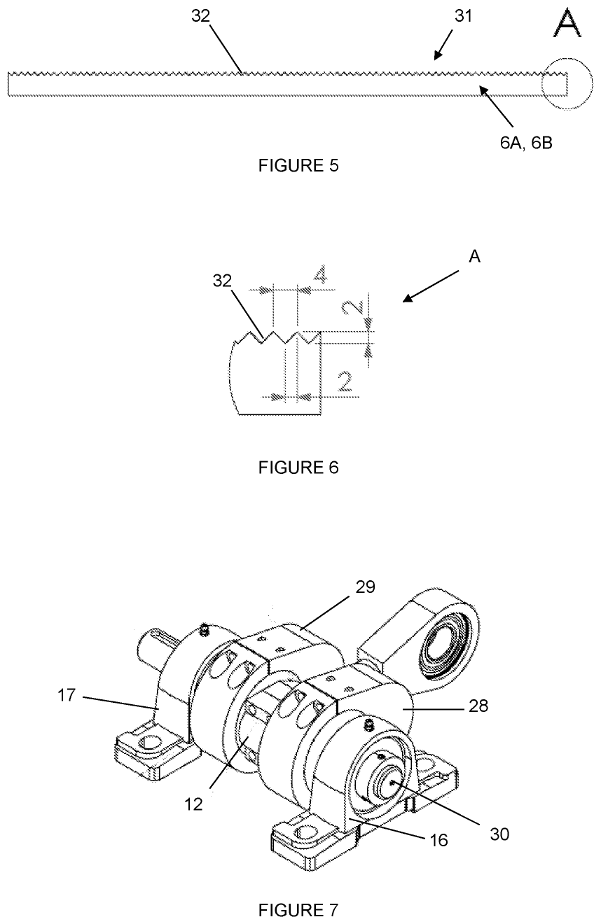

Both cracking plates (6A, 6B) have textured inner surfaces (31). In this embodiment, with special application to pecan nuts, each plate (6A, 6B) has two set of spaced apart grooves (32) as shown in FIG. 5, with detail in FIG. 6. The two sets of grooves (32) are cut a right-angles to each other across the face of the plate. One set of grooves is arranged side-to-side across the face of each plate, and another set of grooves is cut at 90° to the first set, thus being aligned with the vertical direction relative to the cracking space. As shown in FIG. 6, the depth of each groove (32) is about 2 mm, and the distance peak-to-peak between adjacent grooves is about 4 mm.

This creates a gripping surface on each plate (6A, 6B) of a series of crossed troughs with a plurality of spaced apart square ‘pyramids’ rising up from these throughs. Each of the ‘pyramids’ terminate in a sharp tip, which in use creates a surface that grips very well into the outer surface of a nut such as a pecan nut that is about 13 mm in diameter (in this embodiment). The series of spaced apart ‘pyramids’ grip into the nut's shell and prevent it from rolling against the opposing plate's inner surface which is similarly textured. This is the case even if a nut is only gripped against each of the plates (6A, 6B) by a few rows of these ‘pyramids’.

During its motion in the cracking space (21), for an instant each nut is thus halted from rotating and held by and between the gripping surfaces (31), and in that instant pressure from the movable plate (6B) is applied to the nut against the fixed plate (6A), across its width (since the nut cannot move end-to-end between the opposing plates). With the minimum size set at just 1 mm less than the minimum nut size in the range, each nut in the range is gripped and pressured in this manner somewhere along its path though the cracking space (21). That position will typically be where the nut size is larger than the tapered space between the plates when they are closed but smaller than the space between the plates when they are open. In essence, a nut will fall in up to a point where it gets stuck when the movable plate (6B) closes the cracking space (21), at which time it will be subjected a side force.

A nut with a larger diameter (i.e., a nut that is sized higher in the batch's size range) will fill the gap higher up in the cracking space than a nut with a smaller diameter (i.e., a nut that is sized lower in the batch's size range).

The compression force that is applied to the nus is intended to crack the nuts without shattering them. The nut is not rolled at the time that the actual cracking force is applied, and instead it is held stationary, for that instant, between the plates (6A, 6B) by the gripping surfaces (31). This allows for a very consistent and evenly applied force to be applied to the nuts, which promotes cracking instead of shattering.

Due to the angular adjustment of the fixed plate (6A), and the corresponding angular adjustment of the movable plate (6B) at almost the same value to achieve the slightly tapered cracking space (21), a force line perpendicular to the movable plate (6B) is always directed at the same degree slightly upwards relative to the fixed plate (6A). The slightly upward directed force line, in this embodiment being 2° above the perpendicular onto the fixed plate (6A), ensures that nuts are not forced into the cracking space, but instead they are gripped with only enough force to hold them stationary. If the position at which a nut is located at the time that the cracker plates close (in the reciprocating cycle) is too small for the nut's diameter then the nut won't be trapped between the plates but will be more likely be forced upwards to a point in the cracking space (21) where its diameter is closer in size to the space between the plates (6A, 6B) when they are closed. This prevents shattering of nuts and promotes their cracking.

Some pieces of the nuts may splinter off from the nuts and end up between the plates (6A, 6B) where it could potentially clog the gripping surface of a plate (6A, 6B). To address this a compressed air supply pipe is arranged to be directed into the cracking space (21), preferably form the side thereof. At suitable time intervals a burst of compressed air may be directed into the cracking space (21) to dislodge and clear small pieces of nut material from the grooves (32).

The cracking of nuts produces significant forces and amounts of vibration on the equipment involved. This vibration could damage the equipment or affect size settings. To alleviate the vibration, the weights (28, 29) on the reciprocating shaft (30) dampen vibrations that emanate from the cracking action and protects the cracking assembly (5).

To optimise force transmission the connecting rod (12) is configured such that at its maximum travel from the eccentric driven shaft (30), i.e., when the cracking space (21) is at is minimum, the connecting rod (12) is arranged substantially parallel with the base (9). This ensures maximum force transmission to the nuts in the cracking space (21) and a smoother rotation of the driven shaft with less vibration flowing back through the connecting rod (12).

In use the cracking space (21) is set to the correct size as described above, the electric motor (14) is turned on, and nuts are fed into the cracking space (21) between the plates (6A, 6B) from the inlet (the top in this embodiment). The reciprocating motion between the plates (6A, 6B) apply a pure compressive force to the sides of the nuts, which crack them without damaging the nut fruit. Cracked nuts and pieces of shell are collected from below the plates (6A, 6B) for separation.

It will be appreciated that the embodiments described above are given by way of example only and is not intended to limit the scope of the invention. It is possible to alter aspects of the embodiments without departing from the essence of the invention.

In an alternative embodiment of a nut cracker according to the invention that is intended more specifically for pecan nuts, the fixed plate comprises a set of rollers arranged side by side to each other. The axis of rotation of the set of rollers may be arranged from the inlet to the outlet of the cracking space.

In such embodiment the gap between the fixed plate and movable plate is measured from the movable plate to the average level of contact of a pecan nut in the valley between the adjoining rollers. The depth of contact of a nut between the rollers depend on the diameter of the nut, with a small diameter nut being supported deeper between two rollers than a nut with a larger diameter will be supported.

The use of the rollers is anticipated to enable nuts to rotate on their sides as they slide from the inlet to the outlet between two rollers. This rolling action is expected to allow the nuts to be compressed at multiple points around its circumference which will aid the removal of the shell without damaging the nut fruit.

1-13. (canceled)

14. A nut cracker, comprising:
a base adjustably secured to a supporting surface;
a set of cracker plates comprising a movable plate and fixed plate defining a cracking space therebetween with a predeterminable size, the cracking space having an inlet thereto at operatively top ends of the plates and an outlet therefrom at operatively bottom ends of the plates, the fixed plate being adjustably secured to the supporting surface and the movable plate being adjustably secured to at least one slide secured to the base with:
an angle of the fixed plate relative to a plane within which the supporting surface is located being adjustable between 45° and 90°;
an angle of the movable plate relative to a plane within which the base is located being adjustable between 45° and 90°; and
the base being slidingly adjustable relative to the supporting surface to adjust and set the distance between the movable plate and the fixed plate to set a mean size of the cracking space;
wherein the movable plate is movable with respect to the fixed plate with a reciprocating motion along a path parallel to a plane within which the base is located and being constrained for the reciprocating motion by the slide which is slidable between extremities that provide a range of movement greater than a range of the reciprocating movement of the movable plate, and the movable plate being configured to be reciprocally moved by a reciprocating drive that is secured to the base and which reciprocally moves the movable plate on the slide relatively to the base.

15. The nut cracker of claim 14, wherein the angle of the fixed plate relative to the plane within which the supporting surface is located is adjustable between 60° and 70°, and the angle of the movable plate relative to the plane within which the base is located is adjustable between 60° and 70°.

16. The nut cracker of claim 14 wherein the base and the supporting surface are located in parallel planes.

17. The nut cracker of claim 14 wherein the fixed plate is secured to the supporting surface by a set of braces extending from the fixed plate, with the set of braces being securable to a complimentary set of upright supports extending from the supporting surface, with each brace from the set of braces being slidably securable to an upright support by a pin pivotally extending through complimentary apertures through each brace and upright support, with at least one of either brace or support including a slot enabling sliding adjustment of the pin, and operatively enabling adjustment of the angle of the fixed plate relative to the plane within which the supporting surface is located.

18. The nut cracker of claim 14 wherein the movable plate is secured to the slide by a set of braces extending from the movable plate, with the set of braces being securable to a complimentary set of upright supports extending from the slide, and with each brace from the set of braces being slidably securable to an upright support by means of a pin pivotally extending through complimentary apertures through each brace and upright support, with at least one of either brace or support including a slot enabling sliding adjustment of the pin securing the brace and upright support, and operatively enabling adjustment of the angle of the movable plate relative to the plane within which the base is located.

19. The nut cracker of claim 18 wherein the base is provided with a set of spaced apart slides, with each slide having an upright support secured to and extending upwards from it, and with each upright support being slidingly secured to a brace of the movable plate.

20. The nut cracker of claim 19 wherein the two slides are secured together by means of a mounting plate located operatively above the slides, and the two upright supports are secured to and extend upwards from the mounting plate.

21. The nut cracker of claim 20 wherein the mounting plate carries a set of bearings rotatably supporting a driven shaft, which is connected by a connection rod to a reciprocating drive shaft, which forms part of the reciprocating drive.

22. The nut cracker of claim 21 wherein the reciprocating drive comprises a motor with a drive shaft secured to an eccentric driven shaft, with the eccentric driven shaft comprising the reciprocating drive shaft and being connected to the driven shaft by means of the connecting rod that is secured to an eccentric lobe located centrally on the reciprocating drive shaft, and with the reciprocating drive shaft including a set of weights on opposing sides of the eccentric lobe with the weights being co-axial to a central axis of the reciprocating drive shaft.

23. The nut cracker of claim 22 wherein a range of the reciprocating movement of the movable plate is determined by installing an eccentric driven shaft with a throw of the same distance as a desired range of the reciprocating movement.

24. The nut cracker of claim 22 wherein the eccentric lobe has a throw of either 8 mm, 10 mm, or 12 mm.

25. The nut cracker of claim 14 wherein the movable plate and the fixed plate are located between two end brackets to provide closed sides for the cracking space.

26. The nut cracker of claim 14 wherein the base is secured to a worm gear assembly on the supporting surface configured to allow controlled movement of the base relative to the supporting surface, operatively to adjust and set the mean size of the cracking space.
